(19) United States
(12) Patent Application Publication
(10) Pub. No.: US 2010/0319556 A1
(43) Pub. Date: Dec. 23, 2010

(54) LABEL PRINTER

(75) Inventors: Yoshibumi ABE, Fukushima-ken (JP); Eihin Setsu, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/818,730

(22) Filed: Jun. 18, 2010

(30) Foreign Application Priority Data
Jun. 22, 2009 (JP) 2009-147603

(51) Int. Cl. B41F 17/08

(52) U.S. Cl. 101/38.1

(57) ABSTRACT

A label printer includes a tray, a tray transport means, a print mechanism, a disk holding mechanism, a disk release mechanism, a carriage transport means and a control means.

### CROSS REFERENCE TO RELATED APPLICATION

The present invention claims the benefit of and contains subject matter related to Japanese Patent Application JP 2009-147603 filed in the Japanese Patent Office on Jun. 22, 2009, the entire contents of which is incorporated herein by reference.

### BACKGROUND OF THE DISCLOSURE

1. Technical Field

The present invention relates to a label printer that is formed integrally with a disk drive (a driving device) for reading and writing a disc-shaped recording medium to print a desired image on a label surface of the disc-shaped recording medium inserted into the disk drive.

2. Related Art

Recently, with respect to disc-shaped recording media (hereinafter, called a disk) such as a CD-R (Compact Disk Recordable) and a DVD-R (Digital Versatile Disk Recordable), a CD-RW (Compact Disk ReWritable) and a DVD-RW (Digital Versatile Disk ReWritable), necessary information is stored using the respective corresponding driving devices (disk drives) and an original music album, a photograph album, a DVD album or the like can be easily written.

Along with this, there is a growing need to print the label of the written disk with an original design, with the result that various label printers have been developed in which an image of a desired label can be printed on printable regions of the print surface of the disk.

The present inventors previously developed a label printer which is formed integrally with a so-called slot-in-type drive driving means in which the disk is automatically disposed on a disk mounting portion merely by inserting the disk from a slot provided on a front surface of a case to print a desired image on the label surface of the disk to be inserted into the drive driving means (see Japanese Unexamined Patent Application Publication No. 2009-16012).

The label printer includes the drive driving means and the print mechanism in the case which is formed with the slot for inserting and discharging the disk. The drive driving means executes at least one of reading and writing of information with respect to the disk mounted on the disk mounting portion which is drawn into the inner part of the case from the slot by the loading movement of the disk transport means. The print mechanism has a thermal head, which is disposed in the vicinity of the slot in the case on the transport path of the disk between the slot and the drive driving means, to print the desired image on the label surface of the disk.

In addition, in a case where the label is printed with respect to the disk, when an ejection motion is executed which drives the disk from the slot to the outside of the case by means of the disk transport means, a thermal head and a platen roller of the print mechanism, which are disposed on the transport path of the disk between the slot and the drive driving means, press-contact and pinch the disk to print a desired image on the label surface of the disk through the thermal head.

In the above-described label printer configuration, since the label is printed to match the disk with the ejection motion, from during printing to after printing, the disk is held in a state in which a part thereof is extended outside of the case, whereby the feeling of use is poor, and if something comes in contact with a disk that extends during printing, the printing result might be affected.

Thus, when the label is printed, by mounting the disk on the disc-shaped platen in the case again and by driving the thermal head in parallel in a state of being in contact with the disk mounted on the platen so that the spindle of the drive driving means that disturbs the parallel movement of the thermal head can be retreated, a label printer was separately developed which prints a desired label without protruding the disk outside of the case.

Also, with respect to a disk hold and release mechanism that picks up the disk from the drive driving means or the platen and pulls down the disk to the platen or the drive driving means, a printing mechanism with a structure that causes a long thermal head to suitably pressure contact the upper surface of the disk, and a transport mechanism that transports the disk hold and release mechanism and the print mechanism in the arrangement direction of the drive driving means and the platen, there is a need for such mechanisms to be newly invented or mechanisms which solve the problems of the related art to be used.

Specifically, as to the disk hold and release mechanism of the related art, there is a mechanism that grasps the disk by inserting at least three grasping hooks in the center hole of the disk and expanding the grasping hooks in the radial direction to press them in the inner periphery surface of the center hole (see Japanese Unexamined Patent Application Publication No. 2007-310922). However, in the disk hold and release mechanism with the structure that holds the disk by the grasping hooks inserted into the center hole of the disk as described above, the disk cannot be picked up from the drive driving means in which the spindle is inserted into at least the center hole of the disk.

Also, in the related art, there is a print mechanism including a supporting point rotation type head pressure contacting mechanism configured such that a first lever member and a second lever member are combined in a cross shape by a shaft support portion between one end portion and the other end portion to support the one end portion by the frame, ahead attachment platform for attaching the line head is supported by the other end portion and the head attachment platform of the head-up state is pressed by the pressing member, so that the first and second lever members rotate around the shaft support member, whereby the cross angle assembled in the cross shape is made smaller and the head attachment platform descends and the head enters the head down state (see Japanese Unexamined Patent Application Publication No. 2004-74664).

However, in the above-mentioned print mechanism, there was a disadvantage. Due to the difference in thicknesses caused by thickness tolerance of the disk, angles (opening angles) for each head are different from each other and nonuniformity occurs in the print concentration.

Furthermore, there is a print mechanism which is configured such that, as the transport mechanism of the print mechanism of the related art for executing the print, a running belt is installed in the print mechanism (the head unit), thereby moving the print mechanism by the dragging of the running belt (see Japanese Unexamined Patent Application Publication No. 2004-160893). However, it is difficult to belt-transport the print mechanism, which is in the head down state at the predetermined pressure as described above, in parallel, so as not to be shaken in a direction perpendicular to the longitudinal direction of the head, and particularly, there was no mechanism for belt-transporting a thermal head with length of about 12 cm or more in parallel.

These and other drawbacks exist.

### SUMMARY

An object of the embodiments of the invention is to provide a label printer in which a drive driving means is integrated with a print mechanism of a label surface of a disk, the label printer can execute printing of the label surface within a case and has a simple structure with a high quality label printing.

The characteristic of the label printer for achieving the above-mentioned object is that it includes a tray in which on one end side on an upper surface of a tray main body having the shape of a rectangular flat plate, a disk mounting portion of a drive driving means is disposed which records/reproduces information with respect to a disc-shaped recording medium, and on the other end side thereof, a flat bed-shaped platen is disposed, which mounts the recording medium when a desired image is printed on the label surface of the recording medium; a tray transport means which transports the tray main body between an extension position where the one end side of the tray is extended outward from an opening portion formed in an end wall of the printer case to make the recording medium attachable to and detachable from the disk mounting portion, and receiving position where the recording/reproducing of information relative to the recording medium in the printer case or printing of a desired image relative to the label surface of the recording medium is made possible; a print mechanism which has a print means capable of applying an electric current to a thermal head, and a head lifting means that moves the thermal head toward and away from the label surface of the recording medium mounted on the flat bed-shaped platen, the print mechanism being disposed at the upper part of the receiving position of the tray main body in the printer case; a disk holding mechanism that has a carrier including a pair of hook members which are oppositely disposed in a direction perpendicular to the transport direction of the tray main body of the recording medium and are pressed in a direction where they approach each other by a pressing member, thereby being capable of holding the disk, and can hold the disk, and a carrier lifting means for lifting and moving the carrier with respect to the upper surface of the tray main body received in the case; a disk release mechanism that releases holding of the disk against the pressing force of the pressing member relative to the hook members; a carriage transport means that guides a carriage including the print mechanism and the disk holding mechanism by two shafts extended and disposed in the transport direction of the tray main body to reciprocate the carriage; and a control means for controlling the driving of the respective means.

According to embodiments of the present invention, before printing to the label surface by the print means, driving of the carrier lifting means and the carrier transport means are controlled by the control means, and control is performed which mounts and changes the recording medium mounted to the disk mounting portion on the flat bed-shaped platen using the disk release mechanism, and by controlling the driving of the head lifting means and the print means and controlling the driving of the carriage transport means, the label surface can be printed by the print means. Furthermore, before printing of the label, by dropping the carrier by the carrier lifting means to press the pair of hook members to the outer periphery edge of the disk, the disk mounted on the disk mounting portion can be held, and by transporting the carriage that mounts the carrier with the disk held thereon up to the flat bed-shaped platen by the carriage transport means and releasing the holding of the disk through the disk release mechanism, the disk can be mounted in the case again. Moreover, by dropping the thermal head by the head lifting means to press the thermal head to the label surface of the disk, thereby electively applying an electric current to be flowed to the thermal head by the print means in that state, and by transporting the carriage with the print mechanism mounted thereon by the carriage transport means, a desired print can be executed without the thermal head being disturbed by the spindle of the drive driving means and the disk being protruded outside of the case.

In addition, another characteristic of the label printer of the present invention is that the head lifting means of the print mechanism has a head lifting motor that rotates forward and backward, and a screw gear in which a front end portion thereof is connected to the center of a head attachment platform to move the head attachment platform toward and away from the carriage along with the rotation in the forward and reverse directions due to the transmitted rotation force of the head lifting motor.

With the above-mentioned head lifting means, it is possible to securely move the thermal head in the up and down direction.

In addition, another characteristic of the label printer is that the head lifting means of the print mechanism includes a horizontal holding mechanism for holding the head attachment platform with the thermal head attached toward the lower part thereof in the horizontal state. Specifically, the horizontal holding mechanism is a link mechanism including two link plates that are disposed in parallel between first link attachment surfaces, which are formed at line head disposition sides of the upper surfaces of both end portions of the head attachment platform in the longitudinal direction, and second link attachment surfaces, which are vertically provided on the upper surface of the carriage so as to be positioned on the same imaginary surfaces as the corresponding first link attachment surfaces, one end portion side of the link plate in the longitudinal direction is rotatably pivotally supported by the respective first link attachment surfaces, and the other end portion side thereof is rotatably pivotally supported by the second link attachment surfaces, whereby the head attachment platform can be lifted around the rotation axis of the second link attachment surface.

By providing the link mechanism as described above, it is possible to lift the thermal head while being held in the horizontal state.

Furthermore, another characteristic of the label printer that it includes pressing members which are disposed on both ends of the head attachment platform in the longitudinal direction to press the head attachment platform to the carriage side and regulate the balance in both end portions of the head attachment platform in the longitudinal direction.

By means of the pressing members disposed at both ends of the head attachment platform, the head attachment platform is inclined with respect to the up and down direction between the center portion of the head attachment platform with the screw gear disposed therein and a position separated from the center, whereby it is possible to solve the disadvantage such as the occurrence of a difference in pressing contact pressures. In addition, if the thermal head comes in pressure contact with respect to the label surface over the parallel and uniform load, a satisfactory print result can be obtained without generating a difference in print concentrations.

In addition, another characteristic of label printer of the embodiments of present invention is that in the disk release mechanism, an expansion guide portion is formed which is formed so as to expand the pair of hook members in the direction where they are separated from each other against the pressing force of pressing member by horizontally moving the carriage by the carriage transport means. Specifically, the respective hook members include a releasing engagement hook for sliding the expansion guide portion, and a holding movable hook that can be engaged with the outer periphery of the disk to hold the disk.

As described above, by expanding the pair of hook members in the direction to be separated from each other while sliding the expansion guide portion by the horizontal movement of the carriage, holding of the carriage can be released.

Furthermore, another characteristic of the label printer is that the carrier lifting means of the disk holding mechanism includes a carrier lifting motor that rotates forward and backward and a lead screw gear. The front end of the lead screw gear is connected to the center of the carrier, whereby the lead screw gear is stretched to move the carrier toward and away from the carriage along with the rotations in the forward and backward directions due to the transmitted rotation force of the carrier lifting motor.

With the above-mentioned carrier lifting means, the carrier can securely be moved up and down, which makes it possible to reliably hold the disk using the pair of hook members of the carrier.

In addition, other characteristic of the label printer that the carriage transport means includes a plurality of pulleys, an endless-shaped running belt wound around the plurality of pulleys, and a drive means that can transport the running belt in the forward and backward directions by rotating the gear engaged with the running belt, in the running belt, two drawing paths, which concurrently move in parallel in the same direction at a distance equal to or larger than the reciprocating movement distance of the carriage along the transport direction of the tray main body, are disposed between the pulleys so that each drawing path is formed in the vicinity of two shafts. The carriage is fixed such that the thermal head is perpendicular to the transport direction of the carriage with respect to the running belt run in the two drawing paths which concurrently move in parallel in the same direction at the distance equal to or larger than the reciprocating movement distance of the carriage and an imaginary line connecting the hook members is perpendicular to the transport direction of the carriage.

By making the configuration in which the running belt is transported in the multi axes treatment path, the carriage is fixed to the running belt and the two drawing paths are concurrently transported in the same direction, it is possible to drag the carriage at the same speed and the same transport amount at both ends thereof to transport the carriage in parallel. In addition, it is possible to minimize action of the moment between the running belt and the shaft by dragging the vicinity of the shaft by the running belt, whereby damage to the shaft can be prevented.

In addition, one of the pulleys of the label printer is disposed so as to press the wound running belt in a direction to be mounted by the pressing member.

As a result, since the running belt is wound between the pulleys in the proper tension state, transportations of the running belt and the carriage can be performed smoothly.

Label printers according to the various embodiments can improve ease of use by printing the label surface in the case and the structure is simple. Thus a satisfactory printing result regarding the label surface can be obtained.

### BRIEF DESCRIPTION OF THE DRAWINGS

FIG. 1 is a perspective view of parts of a label printer according to an embodiment of the present disclosure.

FIG. 2 is a perspective view of parts of a tray in a label printer according to an embodiment of the present disclosure.

FIG. 3 is a perspective view of parts in a case in a label printer according to an embodiment of the present disclosure.

FIG. 4 is a plan view of parts in a case in a label printer according to an embodiment of the present disclosure.

FIG. 5A is a perspective view that shows a position of a carriage at the time of a disk holding/releasing operation relative to a disk mounting portion.

FIG. 5B is a perspective view showing a position of a carriage at the time of a disk holding/releasing operation relative to a flat bed-shaped platen, in a label printer of according to an embodiment of the present disclosure.

FIG. 6 is perspective view of parts of an upper surface of a carriage in a label printer according to an embodiment of the present disclosure.

FIG. 7 is a perspective view of parts of a print means in a label printer of according to an embodiment of the present disclosure.

FIG. 8 is a plan view of parts that show an arrangement of a print means relative to a carriage in a label printer according to an embodiment of the present disclosure.

FIG. 9 is a perspective view of parts that show an arrangement of a print means relative to a carriage in a label printer according to an embodiment of the present disclosure.

FIG. 10A is a perspective view of parts showing a horizontal holding mechanism in a head up state and a head lifting mechanism.

FIG. 10B is a perspective view of parts showing a horizontal holding mechanism in a head down state and a head lifting mechanism, in a label printer according to an embodiment of the present disclosure.

FIG. 11A is a side view of parts showing a horizontal holding mechanism in a head up state and a head lifting mechanism.

FIG. 11B is a side view of parts showing a horizontal holding mechanism in a head down state and a head lifting mechanism, in a label printer according to an embodiment of the present disclosure.

FIG. 12 is a perspective view of parts of a lower surface of a carrier in a label printer according to an embodiment of the present disclosure.

FIG. 13 is a perspective view of parts of a lower part that shows an arrangement of a carrier relative to a carriage and holding state of a disk in a label printer according to an embodiment of the present disclosure.

FIG. 14A is an enlarged view showing a hook member in a state of holding a disk in a carrier.

FIG. 14B is an enlarged view of parts that show the state of the hook member from a state of holding the disk in the carrier to the release, in a label printer according to an embodiment of the present disclosure.

FIG. 15A is an enlarged view of parts that show a state in which a hook member is in contact with a disk just before holding the disk in the carrier.

FIG. 15B is an enlarged view of parts that show a state in which a hook member is expanded just before holding the disk in the carrier.

FIG. 15C is an enlarged view of parts showing a state of holding a disk in a carrier, in a label printer according to an embodiment of the present disclosure.

FIG. 16A is a side view of parts showing a carrier lifting mechanism in a carrier up state.

FIG. 16C is a side view of parts showing a carrier lifting mechanism in a carrier down state, in a label printer according to an embodiment of the present disclosure.

FIG. 17A is a diagram that shows a positional relationship of a disk and a hook member in a state in which a carrier holds a disk.

FIG. 17B is a diagram that shows a positional relationship of a disk and a hook member in a state in which a carrier releases the holding of a disk, in a label printer according to an embodiment of the present disclosure.

### DESCRIPTION OF EXEMPLARY EMBODIMENTS

The following description is intended to convey a thorough understanding of the embodiments described by providing a number of specific embodiments and details involving label printers. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

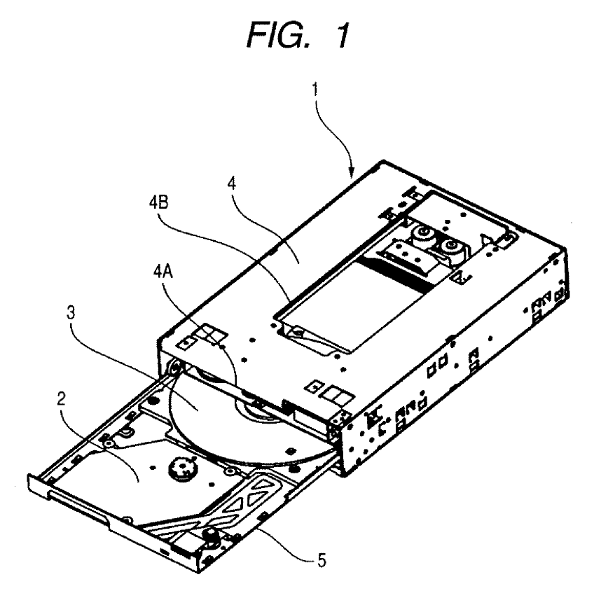

A label printer 1 according to various embodiments of may be a label printer 1 in which a disk driving device 2 (an optical disk driver, hereinafter referred to as merely “ODD 2”) that may record information on an optical disk D (hereinafter, referred to simply as “disk D”), which is a disc-shaped recording medium, or reads and reproduces the information from the disk D is integrated with a print mechanism 3 for performing a desired printing on a label surface DL of the disk D. The label printer may include a case 4 that may be configured so as to be mounted to electric equipment such as a personal computer and may have a width size of approximately 144 mm, for example, a depth size of approximately 215 mm, for example, and a height size of approximately 40 mm (e.g., thin type size) as shown in FIG. 1.

On a bottom surface in the case 4, a tray 5, which may mount the disk D in the label printer 1 when the ODD 2 is driven or when the print mechanism 3 is driven, may be disposed so as to be movable inside and outside of the case from an opening portion 4A formed on one end wall of the case 4 by means of a known tray transport means. Moreover, an opening 4B may be formed on a top surface of the case 4 and is configured such that the carrier 7 moves in a state in which a part of components disposed on an upper surface of a carriage 7 described later may protrude outside of the case. (In addition, in the following description, it is assumed that a direction of one end wall of the case 4 formed with the opening portion 4A is a front part and a direction of the other end wall thereof is a rear part or inside).

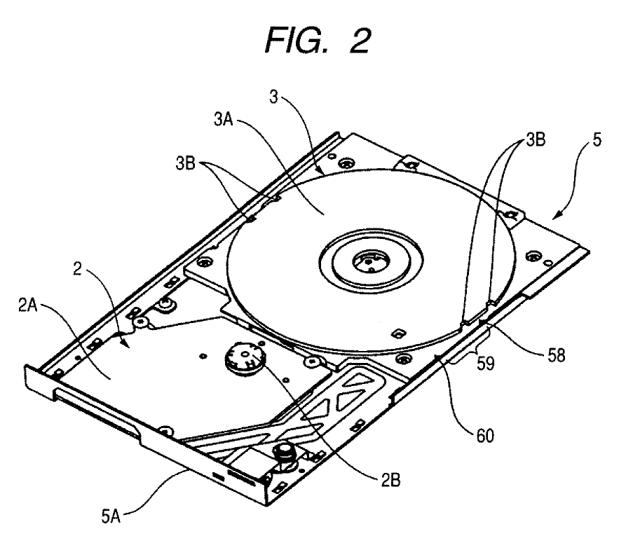

As shown in FIG. 2, the tray 5 may have a tray main body 5A with the shape of a rectangular flat plate. At one end side on the upper surface of the tray main body 5A, a disk mounting portion 2A of the ODD 2 may be disposed which may mount the disk D when recording/reproducing information relative to the disk D. At the other end side thereof, a flat bed-shaped platen 3A with the shape of a disc of the print mechanism 3 may be disposed, which may mount the disk D when printing a desired image on the label surface DL of the disk D. In this embodiment, the disk mounting portion 2A and the flat bed-shaped platen 3A may be formed such that the centers thereof may approach each other to the extent that a spindle 2B, which may rotatably protrude into the center of the disk mounting portion 2A and may be formed so as to be inserted into the hole formed at the center of the disk D, does not influence the printing relative to the disk D mounted on the flat bed-shaped platen 3A.

Furthermore, in the flat bed-shaped platen 3A, a recess 38 may be formed into which a holding movable hook 53B for holding the disk formed in the carriage 51 described later may enter.

In addition, the tray 5 may be movable between a protrusion position where one end side (front part) of the tray main body 5A may be extended from the opening portion 4A to the outside of the case 4 in a state of being supported at one side, so that the disk D can be mounted on the disk mounting portion 2A, and a receiving position where recording/reproducing of information relative the disk D in the printer case 4 or printing of a desired image relative to the label surface DL of the disk D may be possible, by means of a known tray transport mechanism including a tray transport motor (not shown).

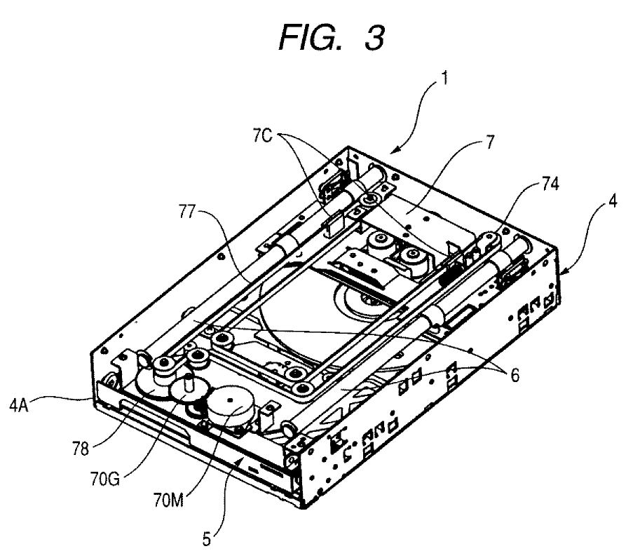

In a space portion which may be the upper part of the tray 5 in the case 4, as shown in FIG. 3, the carriage 7, which may be suspended on two carriage transporting shafts 6 extending in the arrangement direction of the disk mounting portion 2A and the flat bed-shaped platen 3A formed on the tray main body 5A, may be disposed movably between the upper part of the disk mounting portion 2A of the ODD 2 in the case 4 and the upper part of the flat bed-shaped platen IA of the print mechanism 3 along the shafts 6, by means of a carriage transport means 70 including a carriage transport motor 70M.

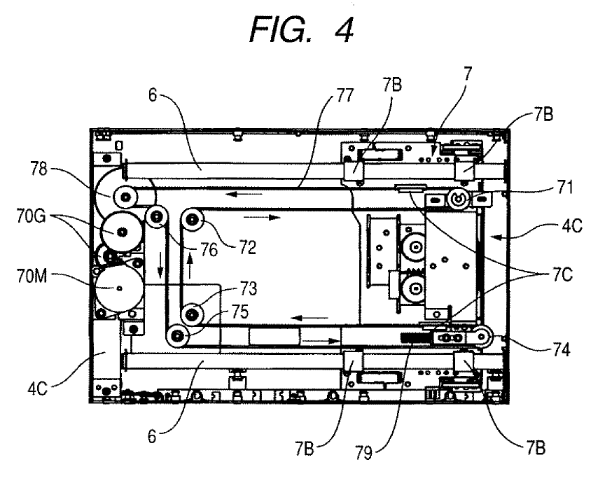

Herein, as shown in FIGS. 3 and 4, the carriage transport means 70 may include a plurality of pulleys 71-76, which may be disposed on an attachment flange portion 4C extending in parallel to the bottom part of the case in the upper space portion of the tray 5, an endless-shaped running belt 77 which may be wound around the plurality of pulleys, and the carriage transport motor 70M that runs the running belt 77 in the forward and backward directions.

The running belt 77 may be disposed (e.g., installed) in the state of applying the tension force among the pulleys 71-76 such that it may extend in the arrangement direction of the disk mounting portion 2A and the flat bed-shaped platen 3A between the two shafts 6 disposed in parallel, may have the distance equal to or more than the reciprocating movement distance of the carriage 7, and two drawing paths which move in parallel in the same direction each may be formed in the vicinity of the two shafts 6.

Herein, the description will be given for the disposition position of a driving pulley gear 78 and the first to sixth pulleys 71-76 that form the drawing path of the running belt 77.

In the attachment flange portion 4C disposed in the vicinity of the opening portion 4A in the case 4, the carriage transport motor 70M, which can rotate forward and backward, may be disposed. In the upper part of the disposition space of the tray 5 in the case 4, at the opening portion side 4A of one (left side in the view in the direction of the opening portion) shaft 6, a driving pulley gear 78 may be disposed to which the rotation force of the carriage transport motor 70M may be transmitted via a gear row 70G and can be rotated forward and rearward.

In the vicinity of the opposite side of the opening portion of the one shaft 6, a first pulley 71 may be rotatably disposed which may return the running belt 77, which may be wound between it and the driving pulley gear 78 and may be extended in the direction of the opening portion. In addition, in the vicinity of the opposite side of the opening portion of the other shaft 6, a fourth pulley 74 may be disposed. In the vicinity of the opening portion side of the other shaft 6, at a position which may be the inner side of the case 4 from the driving pulley gear 78, a fifth pulley 75 may be rotatably disposed.

The inner surface of the endless-shaped running belt 77 may be wound around the driving pulley gear 78, the first pulley 71, the fourth pulley 74 and the fifth pulley 75 to run the running belt 77. In addition, the outer surface of the running belt 77 maybe wound around a second pulley 72, a third pulley 73 and a sixth pulley 76 to run the running belt 77. That is, the second pulley 72 may be rotatably disposed at a position separated from the first pulley 71 to the front of the case 4 more than the movement distance of the carriage 7 so as to extend the running belt 77, which may be wound around the driving pulley gear 78, the first pulley 71, the fourth pulley 74 and the fifth pulley 75, in parallel with the running belt 77 which may be extended between the driving pulley gear 78 and the first pulley 71, and change the direction toward the other shaft 6 side to guide the running belt. In addition, the third pulley 73 may be rotatably disposed at a position which may be an inner side of the case 4 in the vicinity of the fifth pulley 75 so as to extend the running belt 77 in parallel with the end surface of the case 4 in which the opening portion 4A may be formed between the third pulley 73 and the second pulley 72 and extend the running belt 77 in parallel with the running belt 77 which may be extended between the fourth pulley 74 and the fifth pulley 75 between the third pulley 73 and the fourth pulley 74. Additionally, the sixth pulley 76 may be rotatably disposed at the position in the vicinity of the second pulley 72 and the driving pulley gear 78 so as to extend the running belt 77 in parallel with the end surface of the case 4 formed with the opening portion 4A between the fifth pulley 75 and the driving pulley gear 78 and change the direction toward the driving pulley gear 78 side to guide the running belt 77.

In addition, among the first to sixth pulleys 71-76, the fourth pulley 74 may be rotatably disposed in a pulley attachment plate (not shown) which may be movable in parallel with the attachment flange portion 7C, and the pulley attachment plate may be configured so as to press the fourth pulley 74 toward the outer direction to always extend the running belt 77 with a press spring 79. Thus, the fourth pulley 74 may serve as a relaxation catching pulley of the running belt 77.

The running belt 77, which may be spread and extended between the driving pulley gear 78 and the first to sixth pulleys 71-76 disposed as described above, may be configured such that the transport directions are identical to each other based on the rotation direction of the carriage transport motor 70M, in the two belt running paths which extends in parallel, namely, the belt running path between the driving pulley gear 78 and the first pulley 71, and the belt running path between the third pulley 73 and the fourth pulley 74. In addition, similarly, even in the belt running path between the first pulley 71 and the second pulley 72 which may extend in parallel, and the belt running path between the fourth pulley 74 and the fifth pulley 75, the transport directions may be substantially identical to each other.

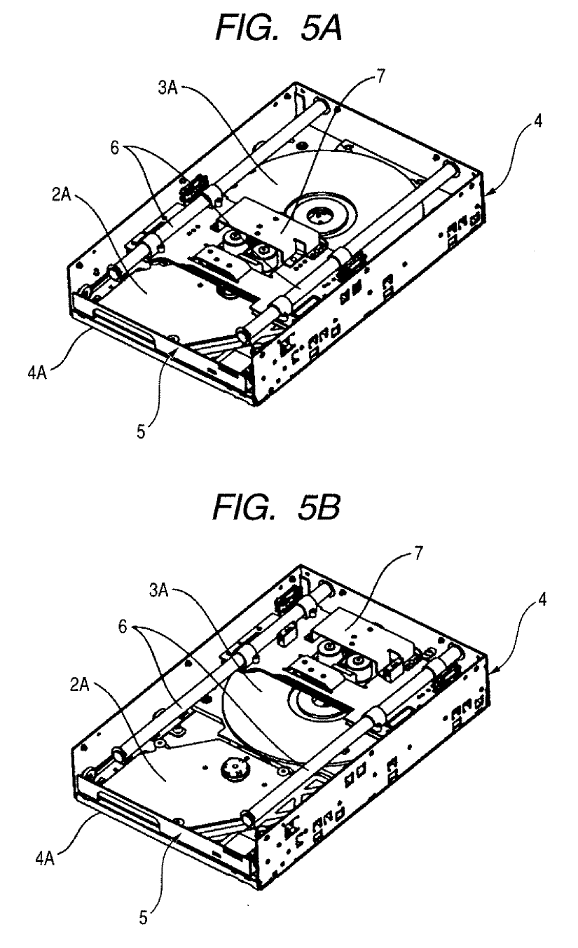

In such an embodiment, the running belts 77, which may reciprocate in the belt running path between the driving pulley gear 78 and the first pulley 71 and the belt running path between the third pulley 73 and the fourth pulley 74, are respectively fixed by a belt fixing portion 7C described below formed in the carriage 7. Thus, by transporting the running belt 77 forward and backward, the carriage 7 can be moved between the upper part (see FIG. 5A) of the disk mounting portion 2A and the upper part (see FIG. 5B) of flat bed-shaped platen 3A in the arrangement direction of the disk mounting portion 2A and the flat bed-shaped platen 3A.

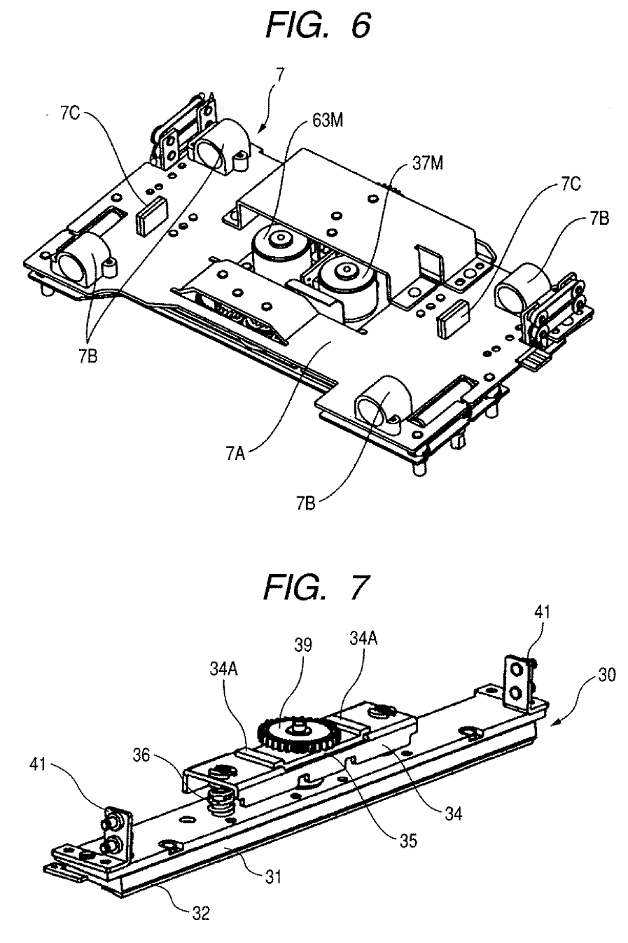

Herein, as shown in FIG. 6, the carriage 7 may have a rectangular carriage main body 7A. On the upper surface of the carriage main body 7A, in the vicinity of two sides extending in the movement direction of the carriage 7, two bearings 7B for inserting the shaft 6 each may be formed. In addition, on the upper surface of the carriage main body 7A, a belt fixing portion 7C may be vertically provided which inserts and fixes a belt portion that runs on the running path between the driving pulley gear 78 and the first pulley 71 and a running belt portion that runs on the running path between the third pulley and the fourth pulley.

In addition, the carriage 7 may include the print mechanism 3 and the disk holding mechanism 50.

As shown in FIGS. 7 to 10, the print mechanism 3 may have a print means 30 that can selectively apply an electric current to a thermal head 32 attached to a long attachment platform 31, and a head lifting means 37 that may move the thermal head 32 toward and away from the label surface DL of the disk D mounted on the flat bed-shaped platen 3A. The print mechanism 3 may be disposed to make the thermal head 32 perpendicular with respect to the transport direction of the carriage 7 in the rear part of the carriage main body 7A which may be the inner side of the case 4.

Specifically, as shown in FIG. 7, in the print means 30, a heating element with a length greater than a maximum print diameter size relative to the disk D provided in printing may be arranged in the shape of a line. The print means 30 may include the thermal head 32 which may be oppositely disposed to be movable toward and away from the label surface DL. The thermal head 32 may be attached to the head attachment platform 31. In addition, a plate-shaped spring plate 34 may be disposed at the center portion of the upper surface of the head attachment portion 31.

A rectangular opening portion may be formed in the center of the upper surface of the spring plate 34. A rectangular plate-shaped screw slide plate 35 may be disposed on a slide rail portion 34A formed at two sides arranged in the extension direction of the thermal head 32 so as to block the opening portion.

On the lower surface of the spring plate 34, a coil spring 36 may be fixed which may operate the elastic pressing force in the up and down direction. The lower end portion of the coil spring 36 may be connected to the upper surface of the head attachment platform 31 with the thermal head 32 disposed thereon to press the thermal head 32 toward the lower part which may be the print position. In addition, an electric current maybe selectively applied to the heating element of the thermal head 32 to meet with the print information.

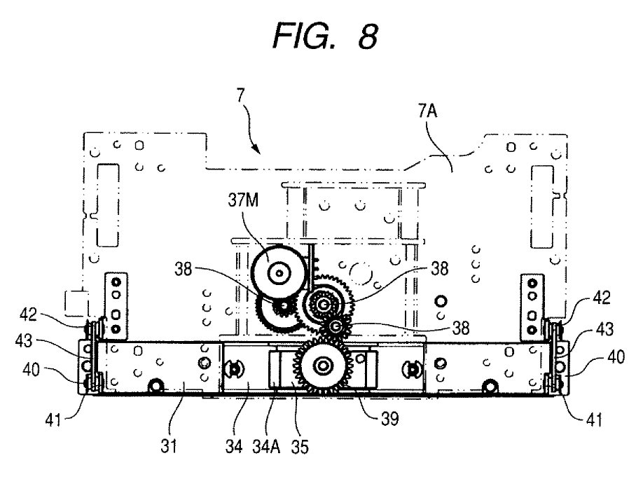

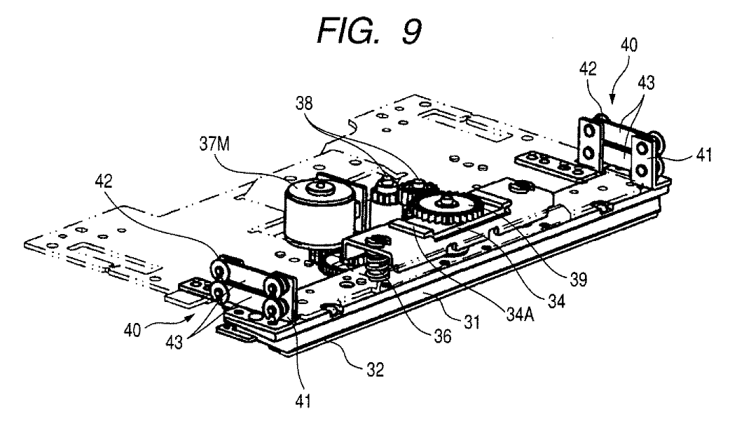

In addition, as shown in FIGS. 8 and 9, the head lifting means 37 of the print mechanism 3 may include a head lifting motor 37M that may rotate forward and backward and screw gear 39 that may rotate in the forward and backward direction due to the rotation force of the head lifting motor 37M to be transmitted via the gear group 38 and may be stretched so as to move the head attachment platform 31 toward and away from the carriage 7. The front end of the screw gear 39 may be screwed into a screw nut (not shown) fixed to the rear surface of the screw slide plate 35 disposed at the center on the spring plate 34.

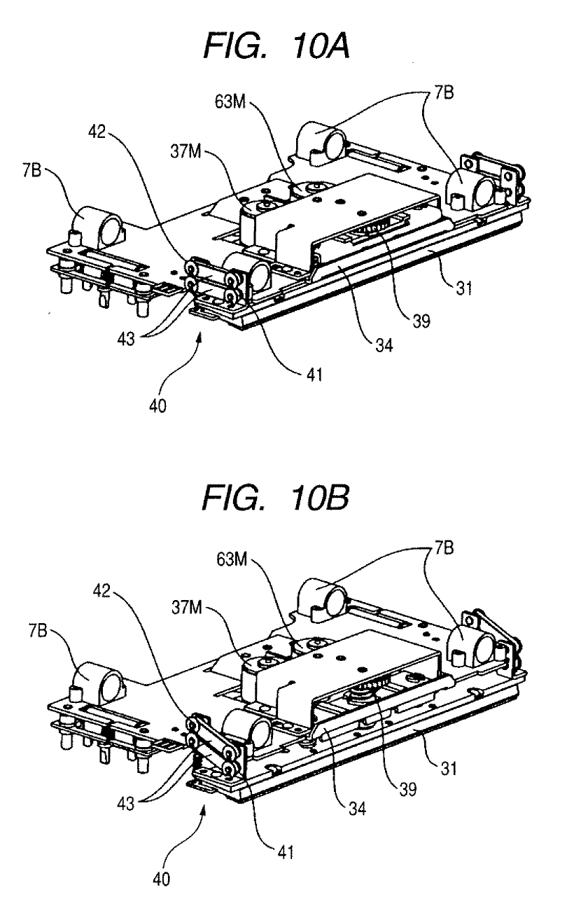

In addition, as shown in FIGS. 9 and 10, the head lifting means 37 of the print mechanism 3 may include a horizontal maintenance mechanism 40 that may maintain the head attachment platform 31 with the thermal head 32 attached downward, in the horizontal state.

The horizontal maintenance mechanism 40 may be a link mechanism that may include first link attachment surfaces 41 which each may be formed on line head disposition sides of the upper surfaces of both end portions of the head attachment platform 31 in the longitudinal direction, and two link plates 43 which each may be disposed in parallel between the first link attachment surfaces and the second link attachment surfaces 42 provided vertically on the upper surface of the carriage 7 so as to be positioned at the same imaginary surface as the corresponding first link attachment surface 41.

The link plates 43 may be rotatably pivotally supported on the respective first attachment surfaces 41 at one end portion side in the longitudinal direction and may be rotatably pivotally supported on the second link attachment surfaces 42 at the other end portion side, whereby the link plates 43 can roll on the head attachment platform 31 around the rotation axis of the first link attachment surfaces 41.

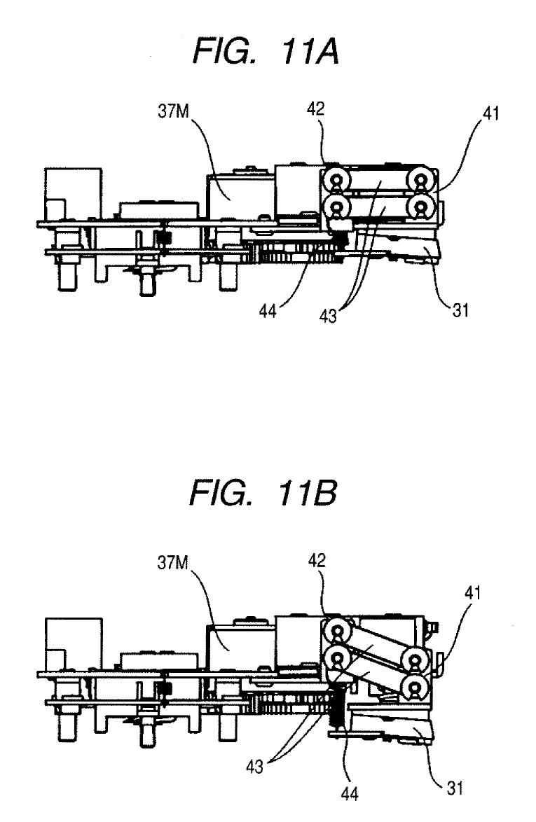

In addition, as shown in FIGS. 10 and 11, at both ends of the head attachment platform 31 in the longitudinal direction, coil springs 44 as pressing members may be disposed which may press the head attachment platform 31 toward the carriage 7 side and regulate the balances in both end portions of the head attachment platform 31 in the longitudinal direction.

When the thermal head 32 is set to be the head down state, the print mechanism 3 with the configuration described above may move the spring plate 34 and the head attachment platform 31 downward while maintaining balances in the longitudinal direction of the thermal head 32 by the coil spring 44 by rotating the head lifting motor 37M forward to rotate the screw gear 39. At this time, the head attachment platform 31 may be slightly drawn rearward by the link mechanism while maintaining the horizontal state, whereby the head attachment platform 31 drops while sliding the spring plate 34 rearward with respect to the screw slide plate 35 (see FIGS. 10B and 11B)

On the contrary, when the thermal head 32 is set to be in the head up state, by rotating the head lifting motor 37M backward to rotate the screw gear 39, the print mechanism 3 may move the spring plate 34 and the head attachment platform 31 upward. At that time, the head attachment platform 31 may be returned to the original state while sliding the spring plate 34 forward with respect to the screw slide plate 35 (see FIGS. 10A and 11A).

In addition, the disk holding mechanism 50 may have a carrier 51 including a pair of oppositely disposed hook members 53, and a carrier lifting means 63 for lifting the carrier 51 with respect to the upper surface of the tray main body 5A received in the case 4 to hold the disk D.

The carrier 51 may be disposed so as to make an imaginary line connecting the pair of hook members 53 perpendicular to the transport direction of the carriage 7 on the front lower surface the print mechanism 3 of the carriage 7.

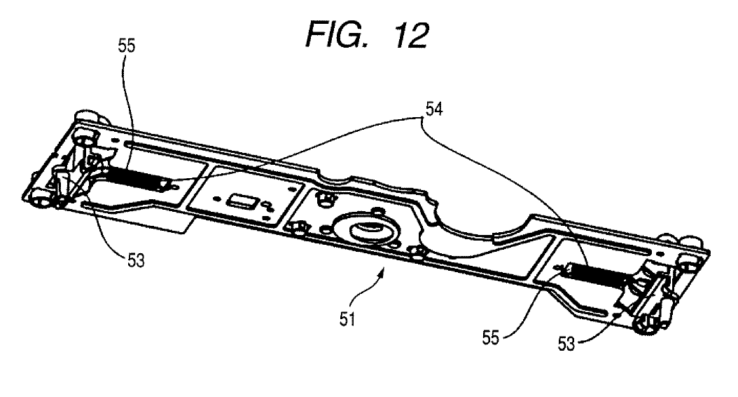

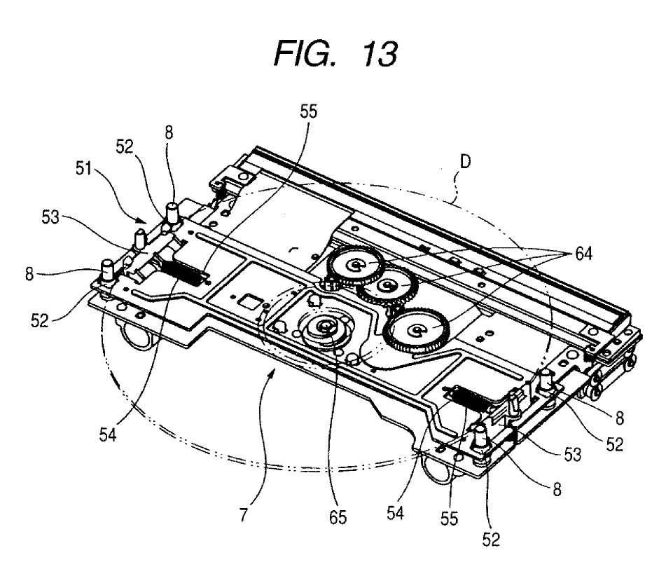

As shown in FIGS. 12 and 13, the carrier 51 may be formed in the shape of a long plate greater than the diameter size of the disk D. At both end portions in the longitudinal direction, two lifting guide holes 52 each may be formed into which the corresponding lifting guide hole 8 formed on the lower surface of the carriage 7 may be inserted, so that the lifting of the carrier 51 is guided.

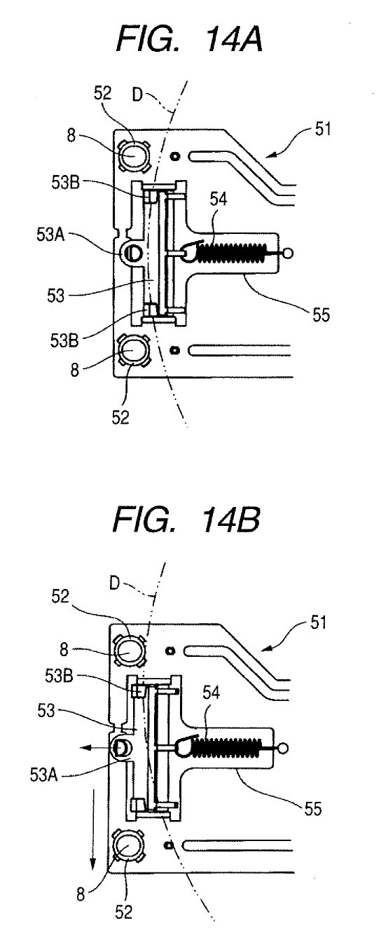

Furthermore, as shown in FIG. 14, in the vicinity of both end portions in the plane of the carrier 51 in the longitudinal direction, approximately T-shaped opening portions 55 each may be formed which may dispose hook members 53 for rotatably pivotally supporting the shaft portion in the width direction of the carrier 51, and coil springs 54 as the pressing member for pressing the hook members 53 in the direction where they approach each other.

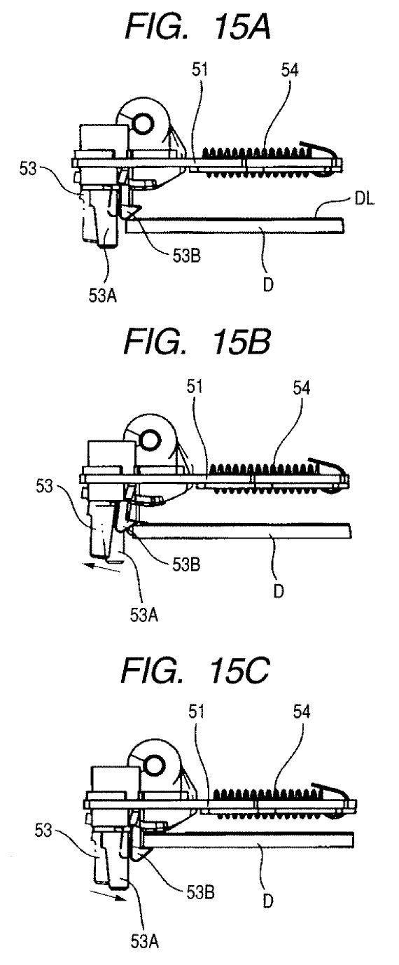

In addition, as shown in FIG. 15, in the respective hook members 53, one releasing engagement hook 53A and two holding movable hooks 53B may be formed such that they directly extend downward to where the tray main body 5A is situated in the state of being pressed by the coil springs 54. The releasing engagement hooks 53A formed in the respective members 53 have approximately cylindrical shapes, are formed to be longer than the holding movable hooks, and the size between the releasing engagement hooks formed in the pair of hook members 53 is equal to or larger than the diameter size of the disk D. Furthermore, two holding movable hooks 53B are in line symmetry by the imaginary line connecting between both releasing engagement hooks in the respective hook members 53, and are positioned at the position where they can be caught in the outer periphery edge of the disk D. As shown in FIG. 15, the front ends of the holding movable hooks 53B are formed in the shape of a hook which is a sloped surface that can guide the disk D between the hook members 53.

In addition, the respective members 53 may press the inclined surfaces formed on the front ends of the holding movable hooks 53B with respect to the outer periphery edge of the disk D by the driving of a carrier lifting means 63 described later. Thus, as shown in FIGS. 15A and 15C, the hook members 53 may be rotated and expanded in the direction where they are separated from each other against the pressing force of the coil spring 54 to house the disk D in the hook portion. Then, the respective hook members 53 rotate again in the direction where they approach each other by the pressing force of the coil spring 54 to hold the disk D between the hook members 53. In addition, when the disk D is released on the flat bed-shaped platen 3A of the print mechanism 3, as shown in FIG. 15B, by guiding the releasing engagement hooks 53A so as to be opened outward by a disk release mechanism 57 described later, the hook members 53 may rotate by the shaft portion to release the engagement with the outer periphery of the disk D.

In various embodiments, on the flat bed-shaped platen 3A, as the disk release mechanism 57 for releasing the holding of the disk D by the pair of hook members 53, an engagement portion 58, an expansion guide portion 59 and a restoring portion 60 may be formed. The engagement portion 58 may be engaged with the releasing engagement hooks 53A of the hook members 53 for holding the disk D. The expansion guide portion 59 may be formed so as to expand the hook members 53 in the direction where they may be separated from each other against the pressing force of the pressing member by horizontally moving the carrier 51 in the state of contacting the releasing engagement hooks 53A. The restoring portion 60 may press the hook members 53 that release the disk D again in the direction where they approach each other by the coil spring 54.

In the present embodiment, as shown in FIG. 2, the disk releasing mechanism 57 may be formed at both sides of the tray main body 5A and the engagement portions 58 may be triangle recesses formed on the imaginary line with the diameter perpendicular to the transport direction of the tray 5 of the flat bed-shaped platen 3A at both sides. In addition, the restoring portion 60 may be situated at the front part from the engagement portion 58 and may be a triangle recess formed at the position where the engagement of the hook members 53 and the disk D is released. The side portions between the inclined sides of the opening portion sides of the recesses of the engagement portions 58 and both recesses 58, 60 may serve as the expansion guide portion 59.

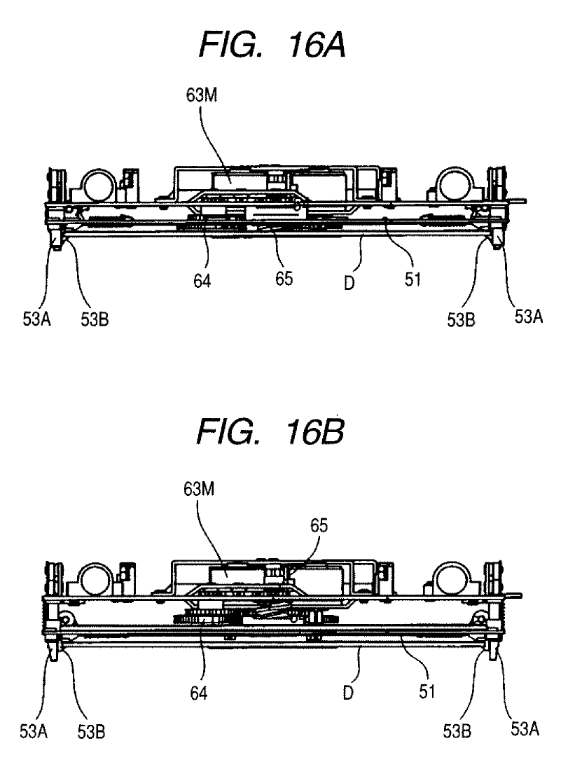

As shown in FIGS. 13 and 16, the carrier lifting means 63 of the disk holding mechanism 50 may include a carrier lifting motor 63M and a screw gear 65. The carrier lifting motor 63M may rotate forward and backward. The front end of the screw gear 65 may be screwed into a screw nut (not shown) fixed to the screw hole formed at the center of the carrier 51 in the longitudinal direction, so that the screw gear 65 may rotate forward and backward due to the rotation force of the carrier lifting motor 63M to be transmitted via the gear group to move the carrier 51 toward and away from the carriage 7.

Furthermore, the drive driving means with the disk mounting portion 2A has a known configuration that may include a sensor (not shown) capable of detecting whether or not the disk D mounted on the disk mounting portion 2A is present, a disk rotation driving mechanism for rotating and driving the disk D mounted on the disk mounting portion 2A, a pick up mechanism for recording/reproducing information with respect to the disk D to be rotated and driven by the disk rotation driving mechanism, and a pick up transport mechanism for transporting the pick up mechanism over the inner and outer peripheries of the disk D.

Moreover, the label printer 1 may include a head lifting motor 37M of the head lifting means 37, a carrier lifting motor 63M of the carrier lifting means 63, and a control means (not shown) for controlling the driving of the carriage transport motor 70M or the like of the carriage transport means 70, in addition to the transport means, the drive driving means and the print means 30. The control means may generate and transport information with respect to the respective means based on the operation input or the like from the user and is, for example, a CPU or a control board disposed in the gap portion of the device.

The control means of the label printer 1 of the present embodiment may use the CPU of the electronic equipment into which the label printer 1 is built as the system control portion. The control means may be connected to a tray control portion for controlling the driving of the tray transport means, an ODD control portion for controlling the driving of the tray driving means, a printer control portion for controlling the application of an electric current to the thermal head 32 of the print means 30, a head lifting control portion for the driving of the head lifting motor 37M, a carrier lifting portion for controlling the driving of the carrier lofting motor 63M, and a carriage transport portion for controlling the driving of the carriage transport motor 70M.

In addition, the disk D used in the present embodiment may be configured such that in the label surface DL, the color recording thermal disk D with the known structure, in which a plurality of coloring layers for generating colors in the substrate formed of a transparent sheet by heating at different temperature regions are provided, maybe adhesively provided. As the thermal disk D, for example, a sheet-shaped thermal disk D disclosed in PCT Japanese Translation Patent Publication No. 2004-570576 and Japanese Unexamined Patent Application Publication No. 2002-370455 can be used.

Hereinafter, the description will be given for control relating to the disk transfer at the time of a print command in various embodiments. Furthermore, when a desired image is printed with the label printer 1, it is proposed that the disk D, in which a sheet-shaped color recording thermal disk D is adhesively provided in the label surface DL, is mounted on the disk mounting portion 2A within the case 4.

That is, when, after recording/reproducing of information with respect to the disk D is performed using the pick up mechanism of the label printer 1, a desired image may be printed continuously, the disk D maybe mounted on the disk mounting portion 2A in advance. Thus, the printer control portion may receive the information with the meaning that the disk D is mounted from the ODD control portion to start the control for printing from this state.

In addition, when only the printing of the desired image using the label printer 1 is performed, the control means may drive the tray transport means by the tray control portion to extend the tray main body 5A outside of the case 4, the user may mount the disk D on the disk mounting portion 2A, and then the tray transport means may be driven again to house the tray main body 5A in the case 4. In addition, the printer control portion may receive the information with the meaning that the disk D is mounted from the ODD control portion to start the control for printing from this state.

In various embodiments, the control means may receive the print command based on the desired recording information from the user. When it is confirmed that the disk D is mounted on the disk mounting portion 2A, the control means may rotate the carriage transport motor 70M forward by the carriage transport control portion to transport the running belt 7, thereby transporting the carriage 7 forward so that the hook portions 53 of the carrier 51 are situated at the immediate upper part of the disk mounting portion 2A. In addition, the standby position (starting point of the carriage) of the carriage 7 may be the innermost portion of the case 4, and the control of the transport amount thereof is managed based on the revolution number (step number) of the carriage transport motor 70M.

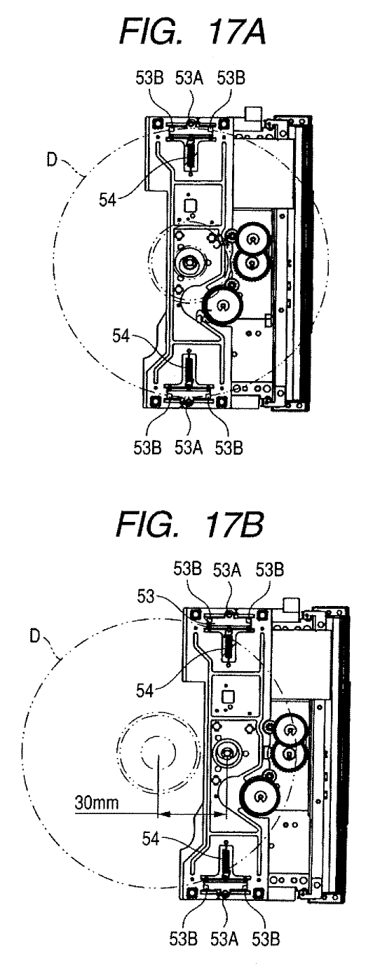

Subsequently, the carrier lifting control portion may rotate the carrier lifting motor 63M of the carrier lifting means 63 forward to rotate the screw gear 65 and drops the carrier 51 which may be at the carrier starting point which maybe the position closest to the rear surface of the carriage 7 to the upper surface of the disk D mounted on the disk mounting portion 2A of the tray main body 5A. In addition, the inclined surfaces formed on the front ends of the holding movable hooks 53B in the pair of hook members 53 may be pressed against the outer periphery edge of the disk D and the hook members 53 may be rotated in the direction where they may be separated from each other against the pressing force of the coil spring 54 to expand between the hook members 53, house the disk D in the holding movable hooks 53B and rotate the hook members 53 in the direction where they approach each other through the pressing force of the coil spring 54 again, whereby the disk D is held between the hook members 53, as shown in FIGS. 14A and 17A. Furthermore, the drop amount at this time maybe set to be a drop amount which is defined in advance so that the hook members 53 are engaged with the disk D.

Next, the carrier lifting control portion may rotate the carrier lifting motor 63M of the carrier lifting means 63 backward to rotate the screw gear 65, and the hook members 53 raise the carrier 51 that holds the disk D up to the carrier starting point. At this time, the insertion of the disk D with respect to the spindle 2A disposed on the disk mounting portion 2A may be released.

In addition, by rotating the carriage transporting motor 70M backward by the carriage transport control portion to transport the running belt 77 backward, the carriage 7 may be transported rearward of the case 4 so that the carrier 51 may be situated just on the flat bed-shaped platen 3A.

Next, the carrier lifting control portion may rotate the carrier lifting motor 63M of the carrier lifting means 63 forward to rotate the screw gear 65, thereby dropping the carrier 51 that holds the disk D to the upper surface of the flat bed-shaped platen 3A of tray main body 5A. At this time, the holding movable hooks 53B for holding the disk D may enter the recesses 38 formed on the flat bed-shaped platen 3A, and the releasing engagement hooks 53A are situated in the recesses as the engagement portions 58 of the release mechanism.

In this state, the carriage transport control portion may rotate the carriage transport motor 70M forward to transport the running belt 77 forward, thereby transporting the carriage 7 forward of the case 4 in which the restoring portion 60 of the disk release mechanism 57 may be formed.

At this time, the releasing engagement hooks 53A may be guided from the engagement portion 58 to the expansion guide portion 59 and the carrier 51 horizontally moves. Thus, as shown in FIG. 14B, the pair of hook members 53 may resist with the pressing force of the pressing member to expand the hook members 53 in the direction where they may be separated from each other. In addition, when the carriage 7 is transported to the position where the restoring member 60 is formed, as shown in FIG. 17B, the holding of the disk D by the holding movable hooks 53B may be completely released. The releasing engagement hooks 53A may be engaged with the restoring portion 60, and the hook members 53 that have released the disk D may be pressed in the direction where they approach each other by the pressing member again.

In addition, the carrier lifting control portion may rotate the carrier lifting motor 63M of the carrier lifting means 63 backward to rotate the screw gear 65 and raise the carrier 51, in which the holding of the disk D by the hook members 53 is released, up to the starting point, and the carriage transport control means portion rotates the carriage transport motor 70M backward to transport the running belt 77 backward, thereby returning the carriage 7 to the carriage starting point.

If the disk D is mounted on the flat bed-shaped platen 3A, the carriage 7 transport control portion may rotate the carriage transport motor 70M forward to transport the running belt 77. Thus, the carriage 7 may be transported backward so that the thermal head 32 of the print means 30 maybe situated just on the foremost print position near the rear end portion of the disk D mounted on the flat bed-shaped platen 3A.

Next, the head lifting control portion may rotate the head lifting means 37M of the head lifting means 37 forward, rotate the screw gear 39 and drop the head attachment platform 31 which may be the head starting portion which may be at the position closest to the rear surface of the carriage 7 to make the thermal head 32 contact the label surface DL of the disk D mounted on the flat bed-shaped platen 3A of the tray main body 5A.

In addition, the carriage transport control portion may rotate the carriage transport motor 70M forward and transport the running belt 77 to transport the carriage 7 forward, and the printer control portion may control the application of an electric current with respect to the thermal head 32 to obtain the desired print.

At this time, thermal head 32 may be dropped while maintaining the horizontal state by providing the link mechanism, and by means of the pressing member disposed on both end portions of the head attachment platform 31, between the center portion of the head attachment platform 31 with the screw gear 39 disposed thereon and the position separated from the center portion, the head attachment platform may be inclined with respect to the up and down direction, and the disadvantage such as the occurrence of the difference in pressing contact pressures is solved, whereby the thermal head 32 comes in press contact with the label surface DL over the parallel and regular load. Thus, a satisfactory print effect can be obtained without generating a difference in print concentrations. In addition, the carriage 7 draws and transports the vicinity of two shafts 6 that bear by means of the running belt 77. At this time, the carriage 7 may be drawn at the same speed by the same transport amount at both ends thereof and is transported in parallel. As described above, by dragging the vicinity of the shaft 6 with the running belt 77, it may be possible to minimize the action of the moment between the running belt 77 and the shaft 6, whereby damage to the shaft 6 can also be prevented.

Control for mounting and changing the disk D on the disk mounting portion 2A from the flat bed-shaped platen 3A:

If printing is finished, the head lifting control portion may rotate the head lifting motor of the head lifting means 37 backward and rotate the screw gear 39 backward to raise the head attachment platform 31 and return to the starting point.

In addition, the carriage transport control portion may rotate the carriage transport motor 70M backward to transport the running belt 77 backward, whereby the carriage 7 may be transported rearward of the case 4 so that the carrier 51 may be situated just on the flat bed-shaped platen 3A.

Next, the carrier lifting control portion may rotate the carrier lifting motor 63M of the carrier lifting means 63 backward and rotate the screw gear 65 to drop the carrier 51 to the upper surface of the flat bed-shaped platen 3A of the tray main body 5A. In addition, the inclined surfaces formed on the front ends of the holding movable hooks 53B in the pair of hook members 53 may be pressed to the outer periphery edge of the printed disk D, the hook members 53 may be rotated in the direction where they are separated from each other against the pressing force of the coil spring 54, the portion between the hook portions is expended, the disk D may be housed in the holding movable hooks 53B, the hook members 53 may be rotated in the direction where they approach each other with the pressing force of the coil spring 54 to hold the disk D between the hook members 53.

At this time, the holding movable hooks 53B for holding the disk D enter the recess 3B formed in the flat bed-shaped platen 3A, and the releasing engagement hooks 53A may be situated in the recess as the engagement portion 58 of the disk releasing mechanism 57.

In addition, the carrier lifting control portion may rotate the carrier lifting motor 63M of the carrier lifting means 63 backward and may rotate the screw gear 65 to raise the carrier 51 that holds the disk D up to the carrier starting point by the hook members 53.

Next, the carriage transport control portion may rotate the carriage transport motor 70M forward and transport the running belt 77 forward, whereby the carriage 7 may be transported forward of the case 4 so that the carrier 51 may be situated just on the disk mounting portion 2A.

Next, the carrier lifting control portion may rotate the carrier lifting motor 63M of the carrier lifting means 63 forward and rotate the screw gear 65 so as to drop the carrier 51 that holds the disk D to the upper surface of the disk mounting portion 2A of the tray main body 5A, and the carrier 51 may be pushed down by the thrust force of the screw gear 65 to insert the center hole of the disk D into the spindle 2A of the disk driving means.

In this state, the carriage transport control portion may rotate the carriage transport motor 70M backward and transport the running belt 77 backward so as to transport the carriage 7 rearward of the case 4 by a certain transport amount.

At this time, in the pair of hook members 53, the holding movable hook 53B which may be situated at the front part among the holding movable hooks 53B, 53B that hold the outer periphery edge of the disk D, may be expanded in the direction where they are separated from each other against the pressing force of the pressing member along the outer periphery edge due to the movement of the carriage 7 to release the holding of the disk D.

In addition, the carrier lifting control portion may rotate the carrier lifting motor 63M of the carrier lifting means 63 backward and rotate the screw gear 65 to raise the carriage 51, which has released the holding of the disk D by the hook members 53, up to the carriage starting point, and the carriage transport control member may rotate the carriage transport motor 70M backward and transports the running belt 77 backward to return the carriage 7 to the carriage starting point.

Next, the tray control portion may drive the tray transport means to discharge the tray main body 5A outside of the case 4 and collect the disk D where the printing is performed.

In addition, the present invention is not limited to the above-mentioned embodiments, but various modifications can be made as necessary.

For example, the label printer of the present invention may be an external connection type label printer that is connected to the electric equipment via USB or the like.

In addition, although in the present embodiment, the collection of the disk after print has been described as performed in the state in which the disk is returned to the disk mounting portion again, the tray may be discharged in the state in which the print is finished and the disk is mounted on the flat bed-shaped platen.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A label printer comprising:
a tray in which on one end side on an upper surface of a tray main body having the shape of a rectangular flat plate, a disk mounting portion of a drive driving means is disposed which records/reproduces information with respect to a disc-shaped recording medium, and on the other end side thereof, a flat bed-shaped platen is disposed, which mounts the recording medium when a desired image is printed on the label surface of the recording medium;
a tray transport means which transports the tray main body between an extension position where the one end side of the tray is extended outward from an opening portion formed in an end wall of a printer case to make the recording medium attachable to and detachable from the disk mounting portion, and a receiving position where the recording/reproducing of information relative to the recording medium in the printer case or printing of a desired image relative to the label surface of the recording medium is made possible;
a print mechanism which has a print means capable of applying an electric current to a thermal head, and a head lifting means that moves the thermal head toward and away from the label surface of the recording medium mounted on the flat bed-shaped platen, the print mechanism being disposed at the upper part of the receiving position of the tray main body in the printer case;
a disk holding mechanism that has a carrier including a pair of hook members which are oppositely disposed in a direction perpendicular to the transport direction of the tray main body of the recording medium and are pressed in a direction where they approach each other by a pressing member, thereby being capable of holding the disk, and can hold the disk, and a carrier lifting means for lifting and moving the carrier with respect to the upper surface of the tray main body received in the case;
a disk release mechanism that releases holding of the disk against the pressing force of the pressing member relative to the hook members;
a carriage transport means that guides a carriage including the print mechanism and the disk holding mechanism by two shafts extended and disposed in the transport direction of the tray main body to reciprocate the carriage; and
a control means for controlling the driving of the respective means.

2. The label printer according to claim 1,
wherein the head lifting means of the print mechanism has a head lifting motor that rotates forward and backward, and a screw gear in which a front end portion thereof is connected to the center of a head attachment platform to move the head attachment platform toward and away from the carriage along with the rotation in the forward and reverse directions due to the transmitted rotation force of the head lifting motor.

3. The label printer according to claim 1,
wherein the head lifting means of the print mechanism includes a horizontal holding mechanism for holding the head attachment platform with the thermal head attached toward the lower part thereof in the horizontal state.

4. The label printer according to claim 3,
wherein the horizontal holding mechanism is a link mechanism including two link plates that are disposed in parallel between first link attachment surfaces, which are formed at line head disposition sides of the upper surfaces of both end portions of the head attachment platform in the longitudinal direction, and second link attachment surfaces, which are vertically provided on the upper surface of the carriage so as to be positioned on the same imaginary surfaces as the corresponding first link attachment surfaces, one end portion side of the link plate in the longitudinal direction is rotatably pivotally supported by the respective first link attachment surfaces, and the other end portion side thereof is rotatably pivotally supported by the second link attachment surfaces, whereby the head attachment platform can be lifted around the rotation axis of the second link attachment surface.

5. The label printer according to claim 2,
wherein it includes pressing members which are disposed on both ends of the head attachment platform in the longitudinal direction to press the head attachment platform to the carriage side and regulate the balance at both end portions of the head attachment platform in the longitudinal direction.

6. The label printer according to claim 1,
wherein in the disk release mechanism, an expansion guide portion is formed which is formed so as to expand the pair of hook members in the direction where they are separated from each other against the pressing force of pressing member by horizontally moving the carriage by the carriage transport means.

7. The label printer according to claim 6,
wherein the hook members include a releasing engagement hook for sliding the expansion guide portion, and a holding movable hook that can be engaged with the outer periphery of the disk to hold the disk.

8. The label printer according to claim 1,
wherein the carrier lifting means of the disk holding mechanism includes a carrier lifting motor that rotates forward and backward and a lead screw gear, the front end of the lead screw gear is connected to the center of the carrier, so that the lead screw gear is stretched to move the carrier toward and away from the carriage along with the rotations in the forward and backward directions due to the transmitted rotation force of the carrier lifting motor.

9. The label printer according to claim 1,
wherein the carriage transport means includes a plurality of pulleys, an endless-shaped running belt wound around the plurality of pulleys, and a drive means that can transport the running belt in the forward and backward directions by rotating the gear engaged with the running belt, in the running belt, two drawing paths, which concurrently move in parallel in the same direction at the distance equal to or larger than the reciprocating movement distance of the carriage along the transport direction of the tray main body, are disposed between the pulleys so that each drawing path is formed in the vicinity of two shafts; and
wherein the carriage is fixed such that the thermal head is perpendicular to the transport direction of the carriage with respect to the running belt run in the two drawing paths which concurrently move in parallel in the same direction at the distance equal to or larger than the reciprocating movement distance of the carriage and an imaginary line connecting the hook members is perpendicular to the transport direction of the carriage.

10. The label printer according to claim 9,
wherein one of the pulleys is disposed so as to press the wound running belt in the a direction to be mounted by the pressing member.

11. A label printer comprising:
a tray in which on one end side on an upper surface of a tray main body having the shape of a rectangular flat plate, a disk mounting portion of a drive driver is disposed which records/reproduces information with respect to a disc-shaped recording medium, and on the other end side thereof, a flat bed-shaped platen is disposed, which mounts the recording medium when a desired image is printed on the label surface of the recording medium;
a tray transporter which transports the tray main body between an extension position where the one end side of the tray is extended outward from an opening portion formed in an end wall of a printer case to make the recording medium attachable to and detachable from the disk mounting portion, and a receiving position where the recording/reproducing of information relative to the recording medium in the printer case or printing of a desired image relative to the label surface of the recording medium is made possible;
a print mechanism which has a printer capable of applying an electric current to a thermal head, and a head lifter that moves the thermal head toward and away from the label surface of the recording medium mounted on the flat bed-shaped platen, the print mechanism being disposed at the upper part of the receiving position of the tray main body in the printer case;
a disk holding mechanism that has a carrier including a pair of hook members which are oppositely disposed in a direction perpendicular to the transport direction of the tray main body of the recording medium and are pressed in a direction where they approach each other by a pressing member, thereby being capable of holding the disk, and can hold the disk, and a carrier lifter that lifts and moves the carrier with respect to the upper surface of the tray main body received in the case;
a disk release mechanism that releases holding of the disk against the pressing force of the pressing member relative to the hook members;
a carriage transporter that guides a carriage including the print mechanism and the disk holding mechanism by two shafts extended and disposed in the transport direction of the tray main body to reciprocate the carriage; and
a controller for controlling the driving of the respective carrier and carriage transporter.
